(19) United States
(12) Patent Application Publication
(10) Pub. No.: US 2015/0222194 A1
(43) Pub. Date: Aug. 6, 2015

(54) Current-Modulated Smart Distribution Transformers, Modules, Systems, and Methods

(71) Applicant: Ideal Power Inc., Austin, TX (US)

(72) Inventor: Paul Bundschuh, Austin, TX (US)

(73) Assignee: Ideal Power Inc., Austin, TX (US)

(21) Appl. No.: 14/608,146

(22) Filed: Jan. 28, 2015

Related U.S. Application Data
(60) Provisional application No. 61/932,422, filed on Jan. 28, 2014.

(51) Int. Cl. H02M 5/12; H02J 3/00

(52) U.S. Cl. CPC H02M 5/12; H02J 3/00

(57) ABSTRACT

A smart transformer comprises a current-modulated electronic power converter with an Alternating Current input (AC Port 1), an Alternating Current output (AC Port 2) and an optional Direct Current input/output (DC Port). A control mechanism allows the converter to provide full AC-AC conversion, changing AC voltage, phase, and power between the two AC ports, with the balance of the power supplied or delivered to the DC port that is connected to an energy storage device.

### CROSS-REFERENCE

Priority is claimed from U.S. patent application 61/932,422 filed 28 Jan. 2014, which is hereby incorporated by reference.

### BACKGROUND

The present application relates to secondary and tertiary distribution of electric power, especially at the point of delivery to a customer's meter, and also, in some embodiments, routing of power behind-the-meter inside a customer's facility.

Note that the points discussed below may reflect the hindsight gained from the disclosed inventions, and are not necessarily admitted to be prior art.

There are many ways to generate electric power, but all are useless unless the power can be delivered to the point where it is needed. Conventionally this is done by stepping up the as-generated voltage (e.g. 2400V) to a high voltage (e.g. 115 kV to 230 kV or more), which is connected to high-voltage transmission lines. The transmission lines carry power to primary distribution substations, where the high voltage is transformed down to “feeder voltage” (e.g. 2400V-13800V or more) for transmission to secondary distribution transformers. The secondary distribution transformer will further transform the voltage down to a “service voltage” (e.g. 240V split-phase or 480V three-phase) for connection to the customer's meter. For customers who use larger quantities of power, the power can be supplied at “subtransmission” or “primary distribution” voltages.

FIG. 3B illustrates the conventional terminology for transmission and distribution voltages, along with some common voltage values. The fundamental advantage of higher voltages is that resistive losses are proportional to current squared; transformation to higher voltage implies lower current, and thus reduces losses. The fundamental disadvantage of higher voltages is that voltage-induced breakdown is always a consideration. This is particularly the case with switches, since individual solid-state switches are limited, with current technology, to a few tens of kV. Series-connected stacks of components can be used to switch higher voltages, but such stacks require care to assure that no switch receives an excessive fraction of the total voltage.

FIG. 3A illustrates the high-level topology of conventional power distribution, and sample voltages. The generating station 310 can be coal-fired, oil-fired, gas-fired, nuclear, wind, solar, process-heat-driven, tidal, or anything else. The as-generated voltage is stepped up by transformer 311 to a much higher transmission voltage, to reduce ohmic losses during transmission over lines 312. Some industrial customers 313 may choose to receive power at the high voltages of the transmission lines 312. Substations 314 convert the power to a lower voltage, and send it over primary distribution lines 315. These primary distribution lines are routed to distribute power over a significant area, e.g. over a small city. “Medium” voltage, lower than 33 kV, is normally used for distribution.

Some large customers 316 (e.g. commercial or government or industrial) may choose to receive their power at the medium voltage which is used for primary distribution, or even at a high voltage (referred to as a “subtransmission” voltage). However, the vast majority of customers 319 will receive power through secondary distribution lines 318 which are connected to a secondary transformer 317. The secondary distribution voltage will normally be a low voltage, typically 600V or less. In the US, residential customers will typically receive 240V split-phase power, or sometimes 208V three-phase power; businesses commonly receive 480V 3-phase power.

An important part of this architecture is not shown: overvoltage protection will typically be located at various locations in the power network, e.g. near switchgear. Such overvoltage protection can be provided by varistors or by vacuum components. This provides protection against transients due to lightning strikes.

Typical secondary distribution topology varies among countries; in the US a single secondary distribution transformer may serve only one or a few residential users, and can therefore have a power capacity as low as 20 kW. In the UK, for example, a single secondary distribution transformer would normally be rated between 315 kVA and 1 MVA, and supply a whole neighbourhood. These are not strict limits, but are mentioned because the inventions described below can have different advantages in these different contexts. In very densely populated areas, “secondary networks” are sometimes used, with many distribution transformers feeding a “grid” at the utilization voltage. This improves reliability since many distribution transformers share the collected load.

In many industrial or commercial sites, power is distributed internally as 480V Y-connected three-phase (or 600V three-phase in some regions). Such installations typically require local stepdown transformers to provide 120V single-phase power (in countries where that is standard). To provide 120V single-phase, the three-phase 480V (or 600V) will often be stepped down to 208V Y-connected three-phase, so that the line-to-neutral voltage is 120V.

Large power transformers often have multiple taps, permitting connection to slightly different points on the higher voltage winding. These different connections change the turns ratio of the transformer, and therefore change the voltage on the secondary side.

Tap adjustment on a de-energized transformer is simple. However, many installations are set up for automatic tap adjustment under load. This requires a more complicated design to prevent arcing, but permits voltage adjustment to be maintained at the transformer.

### Current-Modulated Smart Distribution Transformers, Modules, Systems, and Methods

The present application teaches that conventional passive secondary distribution transformers can be replaced with current-modulation power-converter-based “smart transformer” modules. Such a smart transformer module avoids any need for adjustment of transformer taps, and provides improved power quality on both sides of the converter.

In some embodiments (but not in all), the power converter has three ports: in addition to the high-side and low-side AC ports, a third port is included, which can be specialized for DC connection. This third port permits energy to be stored locally in a battery bank. In other embodiments the power converter has only two ports, and no local energy storage is used.

In some embodiments, but not all, the smart transformer module is used in place of the secondary distribution transformer which would normally be used to provide service voltage. In such embodiments the link inductor (inside the PPSA) can advantageously be implemented as a transformer, to reduce the need for switches which are high-voltage-rated and/or combined in series. The smart transformer module accordingly provides power at the service voltage to one or several customer meters.

In some embodiments, but not all, a smart transformer module is used on the customer side of the meter. Multiple such modules can advantageously be present in a single installation. This permits customers in large installations to easily route power among multiple buildings, or to satisfy the special power needs of critical loads (such as elevators).

In some embodiments, but not in all, multiple smart transformer modules can be interconnected to provide a power distribution network topology which is not strictly hierarchical.

One important advantage of these various innovations is to allow voltage conservation: since the power converters can provide perfect voltage regulation to the loads, the voltage supplied to the smart transformer (or to the customer's meter) can be right at or just barely above the minimum specification. This simplifies the engineering of the transmission network, and of the primary distribution network. Specifically, it means that differences in distribution network impedance can be excluded as a design factor.

Another advantage is that variations in end-user voltage, due to varying load, are eliminated.

Another advantage is that the disclosed distribution architectures inherently provide distributed compensation capability, to avoid power factor variations due to reactive load.

Another advantage is that the disclosed distribution architectures inherently provide distributed compensation capability for phase leg imbalances.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 schematically shows one sample embodiment of a secondary power distribution architecture.

FIG. 2 is one sample embodiment of a high-level architectural diagram of the power transmission and distribution network, showing where a PPSA converter can replace a transformer in secondary or tertiary distribution locations.

FIG. 3A is a high-level architectural diagram of the power transmission and distribution network.

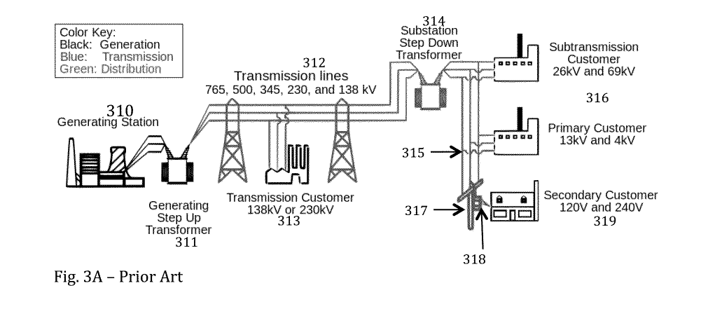

FIG. 3B illustrates the conventional terminology for transmission and distribution voltages, along with some common voltage values.

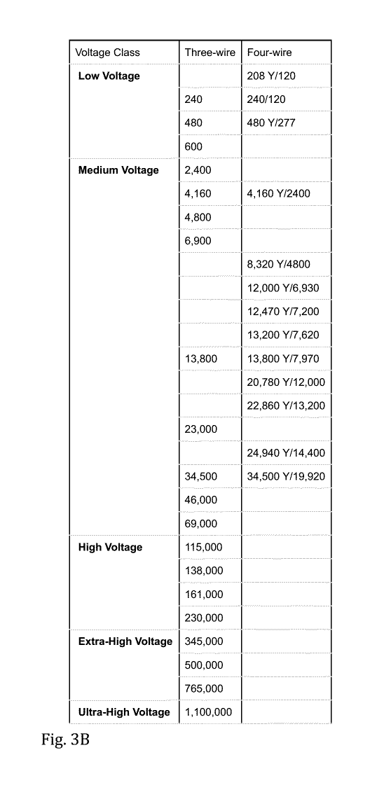

FIG. 4 shows one sample embodiment of a smart-transformer module according to the present inventions.

FIG. 5 shows another sample embodiment of a smart-transformer module according to the present inventions.

FIG. 6 shows a conventional electrical distribution system.

FIG. 7 shows one sample embodiment of a redundant mesh electrical distribution system with smart transformers.

FIG. 8 shows a sample power-packet-switching power conversion architecture.

FIG. 9 schematically shows one sample embodiment of an internal power distribution architecture.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application discloses new approaches to secondary (utility-side) and tertiary (customer-side) power distribution. An electronic power converter replaces the simple transformer which is used in many installations worldwide. By replacing the passive component (transformer) with a smart power supply (preferably a PPSA converter), many surprising benefits and advantages are achieved. In addition to providing the AC voltage reduction provided by conventional transformers, several new functions will be implemented through the disclosed inventions, including e.g.:

1) Voltage Conservation: The AC loads support a range of AC voltages to provide some tolerance in AC voltages from the distribution system. By more tightly controlling the AC voltage to the loads, the nominal AC voltage can be reduced toward the lower voltage limit of the AC loads. This reduces the power delivered to the loads, and can save overall system power.

2) Support for Unbalanced Loads: Three phase AC distribution systems typically assume that the loads on the three phases are relatively balanced. By contrast, the current modulated smart transformer disclosed here can support unbalanced loads between the three phases without additional energy loss and without creating unbalanced load to the input of the smart transformer. This can also simplify and reduce the cost of installing distribution systems in large buildings.

For example in addition to supporting 3-phase loads such as 208 Vac line-to-line, the smart transformer can support unbalanced 120 Vac line-to-neutral loads.

3) Power monitoring and control of loads: Transformers do not provide any control of the power flow. By contrast, the current modulated smart transformer can provide detailed power monitoring information on each port. It can provide separate current and voltage monitoring on each AC phase.

4) Disconnecting non-critical loads when power limited: If single phase loads (line-to-neutral) are connected, and if these loads are arranged so that the highest priority loads are on Phase A, the next highest priority loads are on Phase B and the other loads are on Phase C, then during periods when insufficient power is available for all loads, the current modulation smart transformer can intelligently disconnect lower priority loads, by undersupplying (or cutting off) the phases having the lowest-priority active loads. For micro-grid applications using limited emergency backup power or off-grid power, this feature can significantly reduce system costs related to wiring and controls. Note that no extra components are needed (other than the converter itself), and no changes in wiring are required, to achieve this load-management capability.

5) Support reactive loads: In a perfect world, designers of three phase AC distribution systems could assume that the current and voltage of the load are in phase (i.e. would operate with a power factor of 1). In practice many AC distribution systems need to support highly reactive loads, such as large inductive motors.

Highly reactive loads reduce the efficiency of the distribution system. Some utilities charge commercial and industrial customers higher costs when the customer's power factor varies significantly from 1. Utilities and large customers may use capacitive load banks to balance the inductive loads and bring the overall load to the utility closer to a power factor of 1.

The current modulated smart transformer can support highly reactive (low power factor) loads, both transiently (such as during inductive motor startup) and steady state.

6) Ideal Input: The input to the current modulated smart transformer is seen as a balanced three phase resistive load with a power factor of 1 even when the output power is unbalanced and reactive. There are low harmonics provided back to the input.

7) UPS: With the optional energy storage buffer the current modulated smart transformer output power provides Uninterruptible Power Supply output suitable for critical applications. Additionally voltage sags and other power factor issues are eliminated.

8) Reversible Flow: Every port of the smart transformer including enabling power flow from the lower voltage to the higher voltage side of the systems.

### Secondary Power Distribution Using Smart Transformer-Replacement

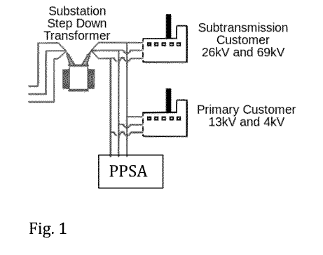

FIG. 1 schematically shows a power distribution architecture, where the conventional secondary distribution transformer 317 has been replaced by a PPSA converter 320. In this example, power at 2300V is received from the power grid, and power at 480V three-phase is supplied to several (from one to seven) customer meters. Secondary distribution transformers will typically have at least a 4:1 step-down ratio—e.g. 2300V or more on the distribution side, and 480V or less on the service side.

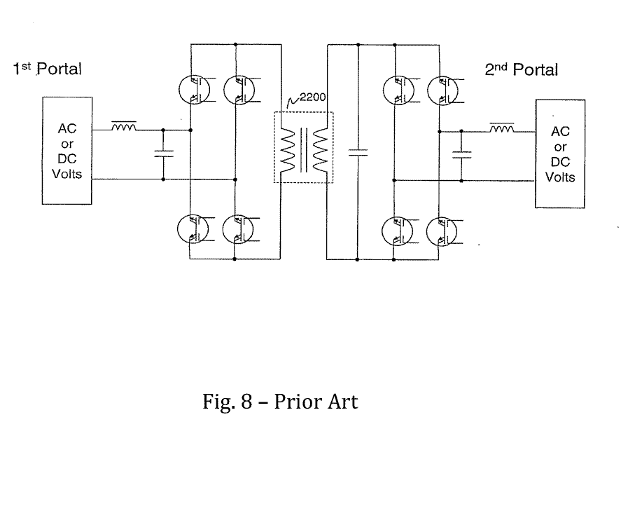

To economize on the cost of switches, the PPSA can be implemented using a transformer as the link inductor. FIG. 8 shows an example of this configuration; here the port on the left side is connected to a secondary distribution voltage (e.g. 2300V), and the port on the right is connected to the customer voltage (e.g. 230V or 480V). The turns ratio of the transformer does not determine the actual voltage conversion ratio—that is determined by the timing used on the input and output switch arrays—but does permit lower-voltage switches to be used on the low-voltage side of the converter. For example, a 4:1 turns ratio can be used here, and the dynamic operation of the converter will provide exactly the desired output voltage.

Switches with lower voltage ratings may be cheaper, and may also provide reduced power dissipation. Higher-voltage switches, for the secondary distribution voltage, can be implemented, for example, with several Silicon IGBTs in series, or with a single SiC IGBT.

### Secondary Power Distribution Using Dumb Stepdown Transformer plus Smart Transformer-Replacement

Since the switch array on the high-voltage side of the PPSA 320 must reliably withstand the secondary distribution voltage, it is preferable that the secondary distribution voltage be relatively small (e.g. 2300V). However, the choice of secondary distribution voltage, once built into a power distribution system's architecture, is not necessarily easy to change. An alternative embodiment is therefore described here.

By including a simple step-down transformer 360 upstream of the smart secondary distribution smart-transformer 320, a wider range of secondary distribution voltages can be accommodated with a single design of the smart-transformer 320. Where the secondary distribution voltage is higher than 2300V, a step-down transformer 360 is chosen which will bring the input voltage to smart-transformer 320. The voltage ratio does not have to be exactly correct, because the smart-transformer 320 will provide the correct output voltage in any case.

The transformer 360 can be “dumb,” i.e. without any automatic tap adjustment. Optionally, it can have no taps at all. This is not typical design practice, but is possible here because the smart-transformer module 320 provides as much flexibility as can possibly be needed.

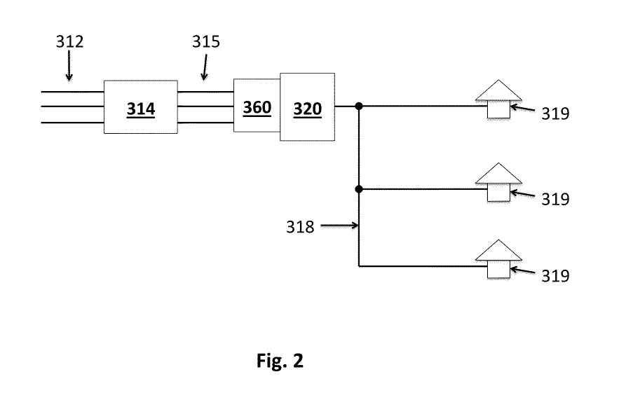

FIG. 2 shows dumb transformer 360 integrated with the smart-transformer module 320, but this would require that the appropriate ratings and clearances be present in the combined package. Where this is not possible, normal power engineering design practices are used to isolate the module 320 from the high-voltage side of dumb transformer 360.

### Tertiary (Customer-Side) Power Distribution Using Smart Transformer-Replacement

A large commercial or industrial facility may have an extensive power distribution network inside the facility. For example, a large department store may have escalators, elevators, and HVAC units which each use a 480V three-phase supply, but (at least in the US) will typically have many 120V single-phase outlets for lights, electronics, vacuum cleaners, etc.

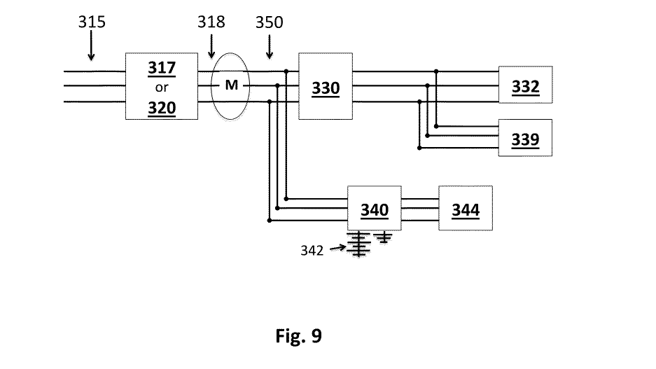

FIG. 9 schematically shows an internal (tertiary) power distribution architecture, where the stepdown transformer has been replaced by a PPSA converter. In this example, power at 480V is received from the main bus (or the meter M), and power at 208V three-phase (and/or 120V single-phase) is supplied to one or more subcircuits.

This can be particularly advantageous in combination with battery backup for critical loads. For example, in FIG. 9, PPSA converter 330 is a two-port converter with two three-phase AC ports, but PPSA converter 340 is a three-port converter which is also connected to a battery bank 342 through a DC port. When the AC supply fails, this converter supplies power to critical loads 344, such as emergency lighting or security alarms. By contrast, converter 330 supplies non-critical three-phase loads 332, as well as non-critical single-phase loads 344.

This drawing shows only one of each component; but of course multiple converters 330 and/or converters 340 can be connected to internal supply bus 350. Similarly, each converter 330 can optionally supply multiple non-critical three-phase loads 332 in parallel (with separate breakers), as well as multiple single-phase loads 334 on different phase pairs. Similarly, each converter 340 can supply multiple critical loads 344, usually on separate subcircuits (which may have separate breakers and/or load-shedding disconnects).

### Power Network Topology

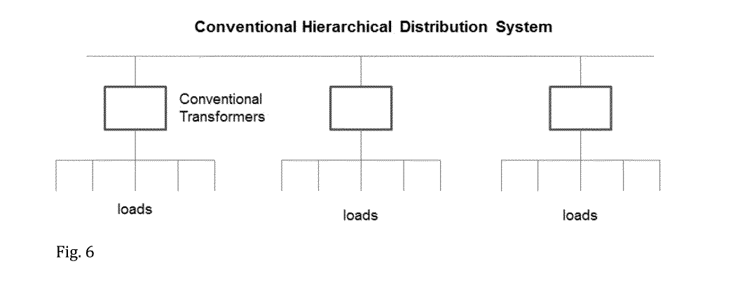

As shown in FIG. 6, conventional electrical distribution systems use a hierarchical distribution, generally without redundancy. The current modulation smart transformer will enable a mesh type distribution with redundancy. This improves reliability, in that a failure in a smart transformer may not cause a wider system failure. This mesh can also improve the distribution efficiency by allowing use of a higher voltage and lower voltage distribution in parallel with multiple smart transformers connecting them at different locations.

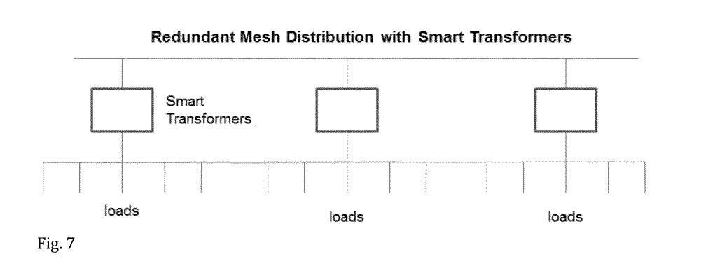

As shown in FIG. 7, PPSA converters are advantageously used to increase the flexibility of redundancy in redundant-supply configurations. For example, if one converter fails, and other converter(s) provide an increased load, the voltage setpoint of the remaining converter(s) can be increased, if needed, to provide voltage conservation.

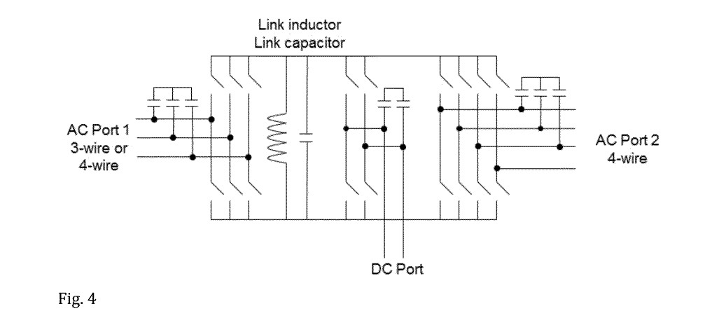

As shown in FIG. 4, a smart-transformer module 320 comprises a current-modulated electronic power converter with an Alternating Current input (AC Port 1), an Alternating Current output (AC Port 2) and an optional Direct Current input/output (DC Port). A control mechanism allows the converter to provide full AC-AC conversion, changing AC voltage, phase, and power between the two AC ports, with the balance of the power supplied or delivered to the DC port that is connected to an energy storage device.

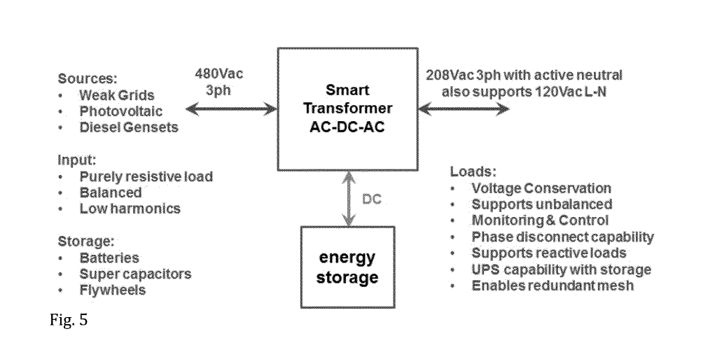

FIG. 5 shows another sample embodiment of a smart transformer module.

### Advantages

The disclosed innovations, in various embodiments, provide one or more of at least the following advantages. However, not all of these advantages result from every one of the innovations disclosed, and this list of advantages does not limit the various claimed inventions.
Improved efficiency in power conversion systems;
Power factor correction;
Voltage conservation;
Power monitoring;
Load control and load-shedding;
Separate control of each phase;
Tolerance for unbalanced loads; and
Higher reliability.
In embodiments where the converter has three ports, the local energy storage avoids voltage sags, and provide increased tolerance for long-duration transients.

According to some but not necessarily all embodiments there is provided: A smart transformer comprises a current-modulated electronic power converter with an Alternating Current input (AC Port 1), an Alternating Current output (AC Port 2) and an optional Direct Current input/output (DC Port). A control mechanism allows the converter to provide full AC-AC conversion, changing AC voltage, phase, and power between the two AC ports, with the balance of the power supplied or delivered to the DC port that is connected to an energy storage device.

According to some but not necessarily all embodiments there is provided: A method of operating a power distribution system, comprising the actions of: in a primary distribution station, using a transformer to step down the voltage of power received from transmission lines, to thereby provide power at a primary distribution voltage on primary distribution lines; in a power-packet-switching converter module, reducing the voltage of power received from said primary distribution lines, to thereby provide a power supply to one or more customers, at a reduced secondary distribution voltage; while also minimizing variation of the secondary distribution voltage, using dynamic response of said converter module.

According to some but not necessarily all embodiments there is provided: A method of operating a power distribution system, comprising the actions of: in a primary distribution station, using a transformer to step down the voltage of power received from transmission lines, to thereby provide power at a primary distribution voltage on primary distribution lines; stepping down the primary distribution voltage, using a transformer which does not have any automatic tap adjustment, to provide an intermediate voltage; and in a power-packet-switching converter module, reducing the intermediate voltage of power received from the transformer, to thereby provide a power supply to one or more customers, at a reduced secondary distribution voltage; while also minimizing variance of the secondary distribution voltage, using dynamic response of said converter module to variations in voltage.

According to some but not necessarily all embodiments there is provided: A method of operating a power distribution system, comprising the actions of: transforming the voltage of incoming power in a primary distribution station, to thereby provide power at a primary distribution voltage on primary distribution lines; and transforming power from said primary distribution lines, using a power-packet-switching converter module, to thereby provide a power supply to one or more customers, at a reduced secondary distribution voltage; and minimizing variance of the secondary distribution voltage, using dynamic response of said converter module to variations in voltage.

According to some but not necessarily all embodiments there is provided: A method of operating a power distribution system, comprising the actions of: in a primary distribution station, using a transformer to step down the voltage of power received from transmission lines, to thereby provide power at a primary distribution voltage on primary distribution lines; stepping down the primary distribution voltage, using a transformer which does not have any automatic tap adjustment, to provide an intermediate voltage; and in a power-packet-switching converter module, reducing the intermediate voltage of power received from the transformer, to thereby provide a power supply to one or more customers, at a reduced secondary distribution voltage.

According to some but not necessarily all embodiments there is provided: A method of operating an electric power system, comprising: generating electrical power; stepping up the voltage of the electrical power to at least a high voltage, and transmitting the electric power over transmission lines; in a primary distribution station, using a transformer to step down the voltage of power received from transmission lines, to thereby provide power at a primary distribution voltage on primary distribution lines; stepping down the primary distribution voltage, using a transformer which does not have any automatic tap adjustment, to provide an intermediate voltage; and in a power-packet-switching converter module, reducing the intermediate voltage of power received from the transformer, to thereby provide a power supply to one or more customers, at a reduced secondary distribution voltage.

According to some but not necessarily all embodiments there is provided: A method of operating an electric power system, comprising: generating electrical power; stepping up the voltage of the electrical power to at least a high voltage, and transmitting the electric power over transmission lines; in a primary distribution station, using a transformer to step down the voltage of power received from transmission lines, to thereby provide power at a primary distribution voltage on primary distribution lines; and in a power-packet-switching converter module, reducing the voltage of power received, to thereby provide a power supply to the meters of one or more customers, at a reduced secondary distribution voltage.

According to some but not necessarily all embodiments there is provided: A power distribution system, comprising: in a primary distribution station, using a transformer to step down the voltage of power received from transmission lines, to thereby provide power at a primary distribution voltage on primary distribution lines; a power-packet-switching converter module which is connected and configured to reduce the voltage of power received, to thereby provide a power supply to the meters of one or more customers, at a reduced secondary distribution voltage, while also automatically minimizing variation of the secondary distribution voltage.

According to some but not necessarily all embodiments there is provided: A power distribution system, comprising: in a primary distribution station, using a transformer to step down the voltage of power received from transmission lines, to thereby provide power at a primary distribution voltage on primary distribution lines; a transformer which does not have any automatic tap adjustment, and which is connected to step down the voltage of power from the primary distribution lines, to thereby provide power at an intermediate voltage; and a power-packet-switching converter module which is connected and configured to reduce the voltage of power received, to thereby provide a power supply to the meters of one or more customers, at a reduced secondary distribution voltage, while also automatically minimizing variation of the secondary distribution voltage.

According to some but not necessarily all embodiments there is provided: A power distribution system, comprising: in a primary distribution station, using a transformer to step down the voltage of power received from transmission lines, to thereby provide power at a primary distribution voltage on primary distribution lines; a transformer which does not have any automatic tap adjustment, and which is connected to step down the voltage of power from the primary distribution lines, to thereby provide power at an intermediate voltage; and a power-packet-switching converter module which is connected and configured to reduce the voltage of power received from the additional transformer, to thereby provide a power supply to the meters of one or more customers, at a reduced secondary distribution voltage.

According to some but not necessarily all embodiments there is provided: An electric power system, comprising: an generating station, which generates electrical power; a step-up transformer, which steps up the voltage of the electrical power to at least a high voltage which is connected to transmission lines; a primary distribution station which uses a transformer to step down the voltage of power received from transmission lines, to thereby provide power at a primary distribution voltage on primary distribution lines; an additional transformer which does not have any automatic tap adjustment, which is connected to step down the voltage of power on the primary distribution lines to thereby provide power at an intermediate voltage; and a power-packet-switching converter module which is connected and configured to reduce the voltage of power received from the additional transformer, to thereby provide a power supply to the meters of one or more customers, at a reduced secondary distribution voltage.

According to some but not necessarily all embodiments there is provided: An electric power system, comprising: an generating station, which generates electrical power; a step-up transformer, which steps up the voltage of the electrical power to at least a high voltage which is connected to transmission lines; a primary distribution station which uses a transformer to step down the voltage of power received from transmission lines, to thereby provide power at a primary distribution voltage on primary distribution lines; a power-packet-switching converter module which is connected and configured to reduce the voltage of power received, to thereby provide a power supply to the meters of one or more customers, at a reduced secondary distribution voltage.

According to some but not necessarily all embodiments there is provided: A power distribution system, comprising: in a primary distribution station, using a transformer to step down the voltage of power received from transmission lines, to thereby provide power at a primary distribution voltage on primary distribution lines; a transformer which does not have any automatic tap adjustment, and which is connected to step down the voltage of power from the primary distribution lines, to thereby provide power at an intermediate voltage; and a power-packet-switching converter module which is connected and configured to reduce the voltage of power received from the additional transformer, to thereby provide a power supply to the meters of one or more customers, at a reduced secondary distribution voltage, while also automatically minimizing variation of the secondary distribution voltage.

According to some but not necessarily all embodiments there is provided: An electric power system, comprising: a generating station, which generates electrical power; a step-up transformer, which steps up the voltage of the electrical power to at least a high voltage which is connected to transmission lines; a primary distribution station which uses a transformer to step down the voltage of power received from transmission lines, to thereby provide power at a primary distribution voltage on primary distribution lines; an additional transformer which does not have any automatic tap adjustment, which is connected to step down the voltage of power on the primary distribution lines to thereby provide power at an intermediate voltage; and a power-packet-switching converter module which is connected and configured to reduce the voltage of power received from the additional transformer, to thereby provide a power supply to the meters of one or more customers, at a reduced secondary distribution voltage, while also automatically minimizing variation of the secondary distribution voltage.

According to some but not necessarily all embodiments there is provided: An electric power system, comprising: a generating station, which generates electrical power; a step-up transformer, which steps up the voltage of the electrical power to at least a high voltage which is connected to transmission lines; a primary distribution station which uses a transformer to step down the voltage of power received from transmission lines, to thereby provide power at a primary distribution voltage on primary distribution lines; a power-packet-switching converter module which is connected and configured to reduce the voltage of power received from the additional transformer, to thereby provide a power supply to the meters of one or more customers, at a reduced secondary distribution voltage, while also automatically minimizing variation of the secondary distribution voltage.

According to some but not necessarily all embodiments there is provided: A tertiary power distribution system, comprising: a first power-packet-switching converter module which has only two ports, and is connected and configured to reduce the voltage of power received through a customer meter, to thereby provide a respective tertiary distribution voltage to first load subcircuits, while also automatically minimizing variation of the secondary distribution voltage; and a second power-packet-switching converter module which has at least two AC ports and at least one DC port, and is connected and configured to reduce the voltage of power received through a customer meter, to thereby provide a respective tertiary distribution voltage to second load subcircuits, while also automatically minimizing variation of the secondary distribution voltage; wherein said second converter module is also connected to supply power to and draw power from said DC port thereof

According to some but not necessarily all embodiments there is provided: A tertiary power distribution system, comprising: a power-packet-switching converter module which is connected and configured to reduce the voltage of power received through a customer meter, to thereby provide a tertiary distribution voltage to one or more internal loads, while also automatically minimizing variation of the secondary distribution voltage.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The two main classes of embodiments described herein are smart secondary distribution transformers (upstream of the customer's meter), and smart tertiary distribution transformers (downstream of the customer's meter). Use in primary distribution transformers is much less advantageous (and less preferred), because of the high voltages which must be tolerated.

In one class of embodiments, the disclosed secondary distribution architecture is used with single-wire-earth-return distribution. (This configuration is commonly used for rural power distribution in the US.) In such embodiments, the dynamic voltage conservation ability of the disclosed smart transformers can be particularly advantageous for voltage conservation, since the impedance seen at the substation can vary, and thus voltage at the customer's meter depends on two unpredictable factors (impedance seen and total current drawn at the substation).

Multiple inventions are disclosed in the present application, and it is also contemplated that synergistic combinations and sub-combinations of devices, methods, and implementations as enablingly described herein will also constitute addition advantageous inventions.

Additional general background, which helps to show variations and implementations, as well as some features which can be implemented synergistically with the inventions claimed below, may be found in the following US patent applications. All of these applications have at least some common ownership, copendency, and inventorship with the present application, and all of them, as well as any material directly or indirectly incorporated within them, are hereby incorporated by reference: U.S. Pat. No. 8,531,858, U.S. Pat. No. 8,514,601, U.S. Pat. No. 8,471,408, U.S. Pat. No. 8,461,718, U.S. Pat. No. 8,451,637, U.S. Pat. No. 8,446,745, U.S. Pat. No. 8,446,043, U.S. Pat. No. 8,446,042, U.S. Pat. No. 8,441,819, U.S. Pat. No. 8,432,711, U.S. Pat. No. 8,406,265, U.S. Pat. No. 8,400,800, U.S. Pat. No. 8,395,910, U.S. Pat. No. 8,391,033, U.S. Pat. No. 8,345,452, U.S. Pat. No. 8,300,426, U.S. Pat. No. 8,295,069, U.S. Pat. No. 7,778,045, U.S. Pat. No. 7,599,196; US 2015-0003115 A1, US 2014-0376291 A1, US 2014-0375287 A1, US 2014-0368038 A1, US 2014-0319911 A1, US 2014-0133203 A1, US 2014-0036554 A1, US 2014-0029320 A1, US 2014-0009979 A1, US 2013-0314096 A1, US 2013-0307336 A1, US 2012-0279567 A1, US 2012-0051100 A1; PCT/US14/16740, PCT/US14/26822, PCT/US14/35954, PCT/U514/35960; Ser. Nos. 14/182,243, 14/182,236, 14/182,245, 14/182,246, 14/183,403, 14/182,249, 14/182,250, 14/182,251, 14/182,256, 14/182,268, 14/183,259, 14/182,265, 14/183,415, 14/182,280, 14/183,422, 14/182,252, 14/183,245, 14/183,274, 14/183,289, 14/183,309, 14/183,335, 14/183,371, 14/182,270, 14/182,277, 14/207,039, 14/209,885, 14/260,120, 14/265,300, 14/265,312, 14/265,315, 14/313,960, 14/479,857, 14/514,878, 14/514,988, 14/515,348; U.S. Provisionals 61/931,785 filed Jan. 27, 2014; 61/932,422 filed Jan. 28, 2014; 61/933,442 filed Jan. 30, 2014; 62/007,004 filed Jun. 3, 2014; 62/008,275 filed Jun. 5, 2014; 62/015,096 filed Jun. 20, 2014; 62/052,358 filed Sep. 18, 2014; 62/054,621 filed Sep. 24, 2014; 62/055,167 filed Sep. 25, 2014; 62/060,312 filed Oct. 6, 2014; 62/063,090 filed Oct. 13, 2014; 62/064,616 filed Oct. 16, 2014; 62/065,916 filed Oct. 20, 2014; 62/073,809 filed Oct. 31, 2014; 62/076,320 filed Nov. 6, 2014; 62/077,777 filed Nov. 10, 2014; 62/081,474 filed Nov. 18, 2014; 62/082,060 filed Nov. 19, 2014; 62/086,561 filed Dec. 2, 2014; 62/094,415 filed Dec. 19, 2014; 62/094,435 filed Dec. 19, 2014; 62/100,301 filed Jan. 6, 2015; 62/101,498 filed Jan. 9, 2015; 62/102,357 filed Jan. 12, 2015; and all priority applications of any of the above thereof, each and every one of which is hereby incorporated by reference.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

1. A method of operating a power distribution system, comprising the actions of:
in a primary distribution station, using a transformer to step down the voltage of power received from transmission lines, to thereby provide power at a primary distribution voltage on primary distribution lines;
in a power-packet-switching converter module, reducing the voltage of power received from said primary distribution lines, to thereby provide a power supply to one or more customers, at a reduced secondary distribution voltage; while also minimizing variation of the secondary distribution voltage, using dynamic response of said converter module.

2. A method of operating a power distribution system, comprising the actions of:
in a primary distribution station, using a transformer to step down the voltage of power received from transmission lines, to thereby provide power at a primary distribution voltage on primary distribution lines;
stepping down the primary distribution voltage, using a transformer which does not have any automatic tap adjustment, to provide an intermediate voltage; and
in a power-packet-switching converter module, reducing the intermediate voltage of power received from the transformer, to thereby provide a power supply to one or more customers, at a reduced secondary distribution voltage; while also minimizing variance of the secondary distribution voltage, using dynamic response of said converter module to variations in voltage.

3. A method of operating a power distribution system, comprising the actions of:
transforming the voltage of incoming power in a primary distribution station, to thereby provide power at a primary distribution voltage on primary distribution lines; and
transforming power from said primary distribution lines, using a power-packet-switching converter module, to thereby provide a power supply to one or more customers, at a reduced secondary distribution voltage; and
minimizing variance of the secondary distribution voltage, using dynamic response of said converter module to variations in voltage.

4-18. (canceled)
